(19) United States
(12) Patent Application Publication
(10) Pub. No.: US 2006/0283122 A1
(43) Pub. Date: Dec. 21, 2006

(54) Deck system

(76) Inventors: Roy Burgess, Lincoln, NE (US); Troy Burgess, Lincoln, NE (US)

Correspondence Address: KRIEGSMAN & KRIEGSMAN, 30 TURNPIKE ROAD, SUITE 9, SOUTHBOROUGH, MA, 01772, US

(21) Appl. No.: 11/146,724

(22) Filed: Jun. 7, 2005

(51) Int. Cl. E04B 9/00; E06B 3/54

(52) U.S. Cl. 52/480

(57) ABSTRACT

A deck system includes a plurality of parallel deck boards which are disposed transversely across a plurality of widely spaced joists. Each pair of adjacent deck boards is fixedly secured to each joist using the combination of a deck clip and a fastener. The deck clip is a unitary plastic member which includes a substantially cylindrical stem and a substantially annular head which are integrally formed together in coaxial alignment with one another, the stem and head together defining a central longitudinal bore. The annular head of the deck clip is sized and shaped to frictionally fit within a slot formed in opposing side edges of the pair of adjacent deck boards. The fastener is preferably in the form of a screw which is sized and shaped to be driven through the longitudinal bore in the deck clip and into the joist, a tapered shelf formed in the deck clip immediately surrounding the bore serving to limit the extent which the fastener can be driven.

### BACKGROUND OF THE INVENTION

The present invention relates generally to the decking industry and more particularly to fastening clips which are used to secure deck boards to transverse support structures such as joists.

Traditionally, a deck is constructed by disposing a plurality of closely spaced, parallel deck boards (each preferably constructed out of a hardwood, composite or synthetic material) across a plurality of widely spaced transverse support beams (which are commonly referred to in the art as joists). In order to strengthen the construction of the deck, the individual deck boards are then fixedly secured to each transverse joist using one or more fasteners. Most commonly, nails are used to secure the plurality of individual deck boards to each of the transverse support beams.

Referring now to FIGS. 1 and 2, there are shown top perspective and section views, respectively, of a prior art deck system 11 of the type described above. Specifically, deck system 11 (also referred to herein simply as deck 11) comprises a plurality of individual deck boards 13 which are disposed transversely across a plurality of widely spaced joists 15, adjacent deck boards 13 being spaced apart a distance D which typically falls within the range of approximately ⅛ of an inch to approximately ½ of an inch (the particular spacing between adjacent deck boards 13 often being selected based on the environmental conditions to which deck 11 will be subjected). With deck boards 13 disposed across joists 15, a plurality of conventional nails 17 are driven down through each deck board 13 and into a corresponding joist 15, as seen most clearly in FIG. 2.

Although widely used in the construction of decks, it has been found that the use of nails to secure deck boards to transverse support beams introduces a number of significant drawbacks.

As a first drawback, it has been found that the use of nails can significantly detract from the overall aesthetics of the finished product. Specifically, when used to secure deck boards to transverse joists, the enlarged metallic head of each nail remains visible, which is highly undesirable.

As a second drawback, it has been found that, if a nail is insufficiently driven through the deck board (i.e., such that the nail head remains disposed slightly above the top surface of the deck board), the exposed nail head serves as a significant safety hazard, which is highly undesirable.

As a third drawback, it has been found that, if the nail is countersunk (i.e., driven to the degree such that the nail head is disposed below the top surface of the deck board), a hole is created in the deck board in which moisture can accumulate. The accumulation of moisture can in turn cause both the deck board to rot (or otherwise decompose) and the nail head to rust, which are both highly undesirable.

As a fourth drawback, it has been found that the requisite hammering process may result in unintentional damage to the individual deck boards. More specifically, during the hammering process, a worker may inadvertently strike the deck board rather than the nail head which, in turn, can result in significant damage to the planks (e.g., denting, marking and/or splitting), which is highly undesirable As a fifth drawback, it has been found that nails are inherently unreliable in retaining the deck boards secured to the transverse joists. In particular, seasonal swelling and/or shrinkage of the deck boards and joists can cause the nails to at least partially pull out. This in turn can weaken the strength of the connection between the deck boards and the joists, which is highly undesirable. As can be appreciated, loosening of the deck boards from the transverse support members can create an unpleasant squeak when pressure is applied thereto (e.g., from walking on the loose planks).

Accordingly, it is known in the deck construction industry to use deck clips (also commonly referred to as decking clips or fastening clips) for securing deck boards to transverse support members. Some of the benefits typically associated with conventional deck clips include, inter alia, (i) the relatively hidden nature of such clips which, in turn, improves the overall aesthetics of the structure and (ii) the improved strength and durability of the bond, or connection, between the planks and the joists.

As an example of a deck clip, in U.S. Pat. No. 4,925,141 to M. Classen, there is disclosed a relatively simple, one nail deck bracket which includes a planar body with prongs extending outwardly from each side thereof for uniformly spacing and interconnecting adjacent planks, and a planar arm extending downwardly from the bottom edge of the body in a plane perpendicular to or otherwise angled with respect to the plane of the body for bearing against one side of the joist, the arm having a hole for receiving a nail for connecting the bracket to the joist. Two arms can be provided at opposite ends of the body for, in effect, straddling the joist.

As another example of a deck clip, in U.S. Pat. No. 5,997,209 to R. J. Sachs, there is disclosed a fastener for timber decking, fences, pallets and the like which comprises a joist attachment plate with one or more fastening apertures therein, one or more spacing flanges locatable between joists and planks, a plank spacer extending between adjacent planks and axially aligned plank engaging teeth extending from opposed sides of the plank spacer to engage respective side surfaces of adjacent planks.

As another example of a deck clip, in U.S. Pat. No. 4,844,651 to J. W. Partridge, there is disclosed a fastening clip for use in wooden deck construction and the like which comprises a rectangular strip of galvanized steel having a stamped-out central portion forming a perpendicular shank terminating in a parallel arrowhead-like end for piercing the edge of a wooden plank. Nailing or screwing holes are provided in the strip on either of stamped-out portion.

Although useful in securing deck boards to joists, deck clips of the type described above suffer from a few notable shortcomings.

As a first shortcoming, each of the above-described deck clips is relatively complex in construction. Notably, each deck clip is constructed from a sheet of metal which, through multiple stages of stamping and folding, is shaped into its desired configuration. As can be appreciated, this complex manufacturing process renders such clips relatively expensive to manufacture, which is highly undesirable.

As a second shortcoming, each of the above-described deck clips has a non-symmetrical construction about its longitudinal axis. As a result, each deck clip must be disposed in a particular orientation when used to secure deck boards to joists. Accordingly, it has been found that these clips require a relatively high level of manual dexterity to use, which is highly undesirable.

As a third shortcoming, deck clips of the type described above are typically manufactured out of a metallic material, such as steel. As a consequence, such clips are rendered highly susceptible to corrosion when exposed to moisture (e.g., rain, snow, etc.), which is highly undesirable.

### SUMMARY OF THE INVENTION

It is an object of the present invention to provide a new and improved deck system.

It is another object of the present invention to provide a new and improved deck system which is aesthetically pleasing.

It is yet another object of the present invention to provide a deck system as described above which is strong, durable and reliable.

It is still another object of the present invention to provided a deck system which includes a deck clip for use in securing deck boards to transverse support beams.

It is yet still another object of the present invention to provide a deck system as described above which utilizes a deck clip that has a limited number of parts, that is easy to use and that is inexpensive to manufacture.

Therefore, according to one feature of the present invention, there is provided a deck system comprising (a) a joist, the joist comprising a top edge and a bottom edge, (b) a pair of deck boards disposed transversely across the top edge of the joist, each deck board comprising a top surface, a bottom surface and a pair of side edges, each deck board being shaped to define a slot in at least one of its side edges, (c) a deck clip shaped to define a longitudinal bore, the deck clip comprising a substantially cylindrical stem and a substantially annular head which are in coaxial alignment with one another, the annular head of the deck clip being sized and shaped to frictionally fit within the slot formed in each of the pair of deck boards, and (d) a fastener sized and shaped to extend through the longitudinal bore in the deck clip and into the joist.

According to another feature of the present invention, there is provided a deck clip for use in securing at least one deck board to a joist, the deck clip comprising (a) a stem, and (b) an enlarged head formed on the stem, the head and the stem being shaped to define an elongated bore and a longitudinal axis, (c) wherein the enlarged head is substantially symmetrical about the longitudinal axis.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings wherein like reference numerals represent like parts:

FIG. 1 is a fragmentary, top perspective view, broken away in part, of a prior art deck system;

FIG. 2 is a section view of the prior art deck shown in FIG. 1 taken along lines 2-2;

FIG. 3 is a fragmentary, top perspective view, broken away in part, of a novel deck system constructed according to the teachings of the present invention;

FIG. 4 is a section view of the deck system shown in FIG. 3 taken along lines 4-4;

FIG. 5 is an enlarged fragmentary section view of the deck system shown in FIG. 4;

FIG. 6(a) is an enlarged, top perspective view of the deck clip shown in FIG. 5;

FIG. 6(b) is an enlarged, bottom perspective view of the deck clip shown in FIG. 5;

FIG. 6(c) is an enlarged, bottom plan view of the deck clip shown in FIG. 5;

FIG. 6(d) is an enlarged, front plan view of the deck clip shown in FIG. 5; and

FIG. 6(e) is a section view of the deck clip shown in FIG. 6(a) taken along lines 6(e)-6(e);

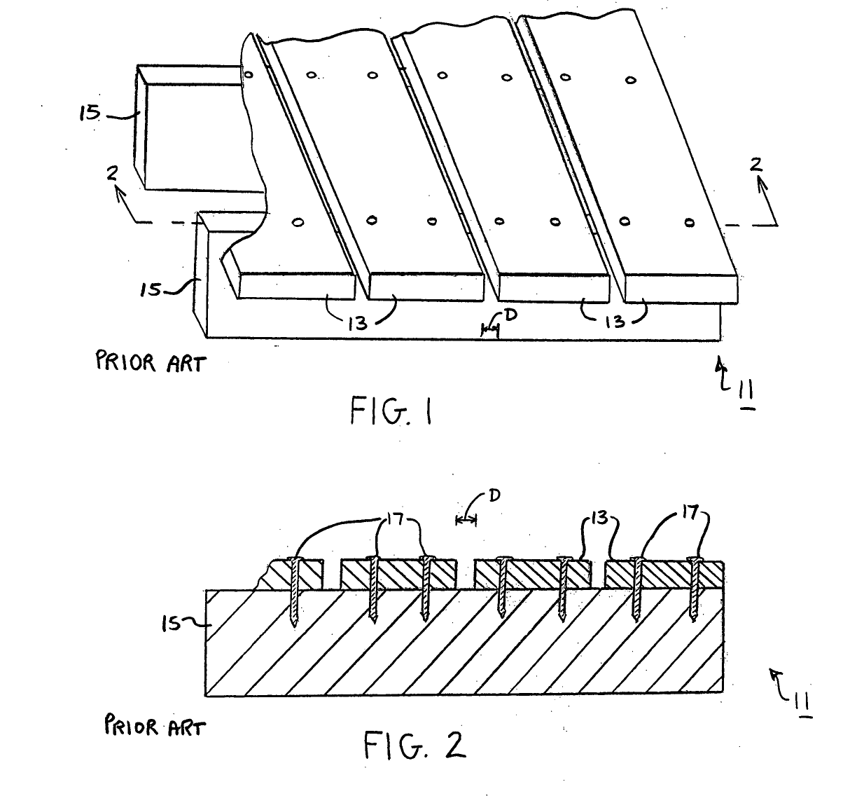

### DETAILED DESCRIPTION OF THE PREFERRED EMBODIMENT

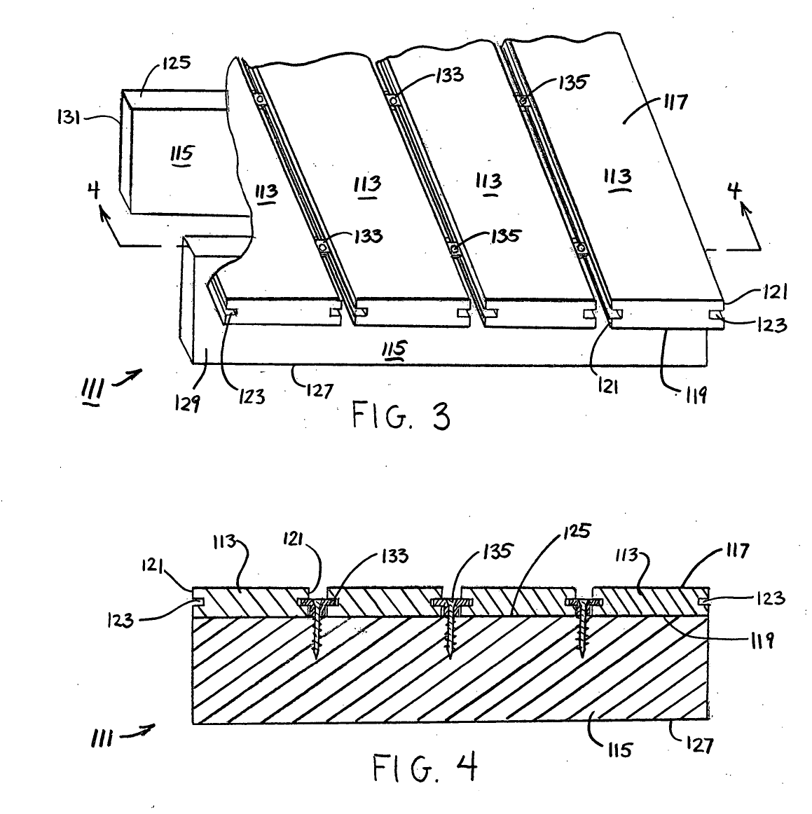

Referring now to FIGS. 3 and 4, there is shown a novel deck system that is constructed according to the teachings of the present invention, the deck system being identified generally by reference numeral 111.

Deck system 111 comprises a plurality of parallel deck boards 113 which are disposed transversely across a plurality of widely spaced joists 115. As will be discussed further below, deck boards 113 are fixedly secured in position across joists 115 to reinforce the structural integrity of deck system 111.

Each deck board 113 (also referred to herein as either plank 113 or decking 113) is preferably constructed out of a hardwood, composite or synthetic material (e.g., a conventional 2×4 wooden plank) and includes a substantially flat top surface 117, a substantially flat bottom surface 119 and a pair of side edges 121. As seen most clearly in FIG. 3, each side edge 121 is preferably shaped to define a narrow groove, or slot, 123 which extends longitudinally along its length at the approximate midpoint between top surface 117 and bottom surface 119, groove 123 having a substantially rectangular shape in lateral cross-section.

It should be noted that the groove 123 formed into each side surface 121 need not extend the entire length of deck board 113. Rather, it is to be understood each groove 123 may alternatively extend only a fraction of the length of deck board 113 without departing from the spirit of the present invention. In those circumstances, a hand-held biscuit jointer or router may be used to form the shortened groove 123 in the deck board 113.

Each joist 115 (also referred to herein as either support member 115 or support beam 115) is preferably constructed out of a hardwood, composite or synthetic material and includes a substantially flat top edge 125, a bottom edge 127, a front surface 129 and a rear surface 131. As seen most clearly in FIG. 4, the bottom surface 119 of each deck board 113 rests directly on top of the top edge 125 of each transverse joist 115.

Preferably, successive joists 115 are spaced a considerable distance apart from one another (e.g., in the range of approximately 12-24 inches), as seen most clearly in FIG. 3. In this manner, it is to be understood that the function of joists 115 is to support the plurality of individual deck boards 113 which are disposed transversely across its top edge 125.

Deck boards 113 are fixedly secured to joists 115 at multiple locations using the combination of a deck clip 133 and a fastening device 135. As seen most clearly in FIG. 5, each deck clip 133 is sized and shaped to engage the opposing side surfaces 121 of adjacent deck boards 113. In turn, fastening device 135 is designed to secure deck clip 133 to joist 115. In this manner, deck clip 133 and fastening device 135 together serve to secure a pair of adjacent deck boards 113-1 and 113-2 fixedly against the top edge 125 of a transverse joist 115, as will be described further in detail below.

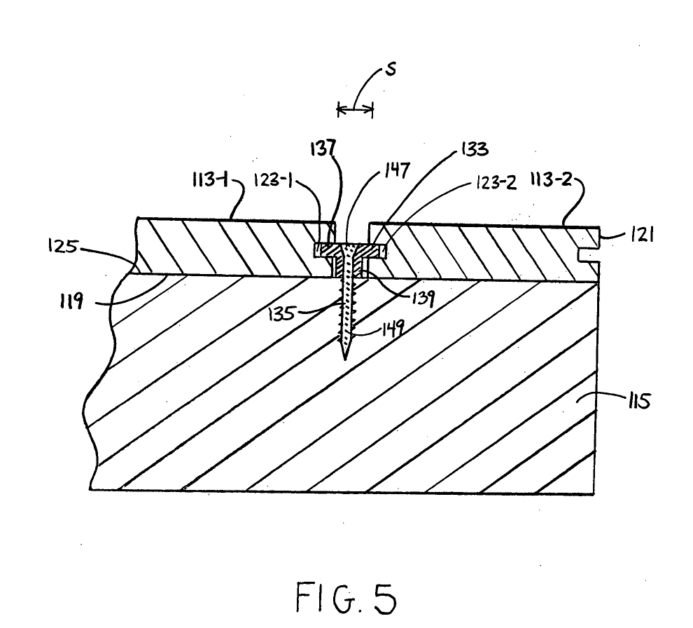

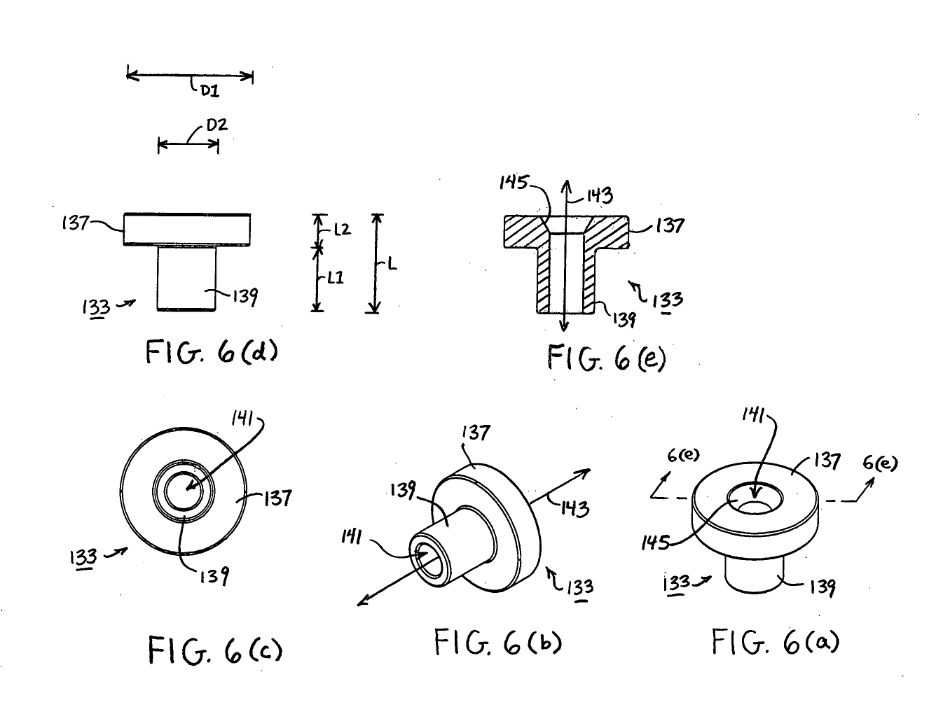

Referring now to FIGS. 6(a)-(e), deck clip 133 is a unitary device that is preferably constructed out of a rigid and durable plastic material, such as glass-filled nylon or polyvinyl chloride (PVC), using conventional molding techniques. However, it is to be understood that deck clip 133 could be constructed out of other types of rigid and durable materials, such as metal, without departing from the spirit of the present invention.

Deck clip 133 has a generally spool-like design. Specifically, deck clip 133 comprises an enlarged annular head 137 that is integrally formed onto a cylindrical stem 139, head 137 and stem 139 being co-axially aligned. Together, head 137 and stem 139 define an elongated bore 141 which extends longitudinally through deck clip 133, bore 141 having circular shape in lateral cross-section. As will be described further below, bore 141 is sized and shaped to fittingly receive fastener 135.

Preferably, deck clip 133 has an overall length L of approximately 0.478 inches, with stem 139 having a length L1 of approximately 0.322 inches and head 137 having a length L2 of approximately 0.156 inches. In addition, head 137 preferably has an outer diameter D1 of approximately 0.625 inches and stem 139 preferably has an outer diameter D2 of approximately 0.288 inches. However, it should be noted that deck clip 133 is not limited to any particular set of dimensions. Rather, it is to be understood that the dimensions of deck clip 133 could be modified without departing from the spirit of the present invention.

It should be noted that deck clip 133 defines a longitudinal axis 143 which extends through the center of bore 141. As a result, it is to be understood that deck clip 133 has a substantially symmetrical design about its longitudinal axis 143. As can be appreciated, due to its substantially symmetrical construction about its longitudinal axis, deck clip 133 need not be rotated in any particular position about longitudinal axis 143 when used to secure deck boards 113-1 and 113-2 against transverse joist 115, which is a principal novel feature of the present invention.

As seen most clearly in FIG. 6(e), bore 141 tapers gradually outward at an approximate 60 degree angle towards the free end of head 137 so as to define a tapered shelf 145, the diameter of bore 141 increasing from approximately 0.170 inches (within stem 139) to approximately 0.277 inches (at the free end of head 137). As will be discussed further below, tapered shelf 145 is sized and shaped to support the head of fastening device 135, thereby preventing fastening device 135 from being driven entirely through deck clip 133 in use.

As seen most clearly in FIG. 5, fastening device 135 (also referred to herein as fastener 135) is preferably in the form of a screw which includes an enlarged head 147 and an elongated threaded stem 149. For example, fastening device 135 may be a highly quality stainless #1 square drive screw. However, it should be noted that fastening device 135 is not limited to screws. Rather, it is to be understood that fastening device 135 represents any conventional fastening device which is commonly used to secure together two or more pieces of wood (e.g., a nail) without departing from the spirit of the present invention.

Together, deck clip 133 and fastening device 135 can be used in the following manner to secure a pair of adjacent deck boards 113-1 and 113-2 to a transverse joist 115. Specifically, referring now to FIG. 5, with deck board 113-1 disposed transversely across joist 115, deck clip 133 is positioned such that its enlarged head 137 fittingly protrudes into groove 123-1 in deck board 113-1 and such that the free end of its stem 139 lies flush against (or in close proximity to) top edge 125 of joist 115. It should be noted that a rubber mallet may be used to drive enlarged head 137 of deck clip 133 into groove 123-1.

With head 137 of deck clip 133 disposed within groove 123-1, deck board 113-2 is similarly disposed transversely across joist 115 such that deck clip 133 is positioned between deck boards 113-1 and 113-2. Deck board 113-2 is then drawn in towards deck board 113-1 until enlarged head 137 of deck clip 133 fittingly protrudes into its longitudinal groove 123-2. A rubber mallet, or other similar instrument, may be used to drive enlarged head 137 of deck clip into groove 123-1.

With head 137 of deck clip 133 disposed in frictional engagement with boards 113-1 and 113-2, fastener 135 is used to secure deck clip 133 against joist 115. Specifically, stem 149 of fastener 135 is disposed through bore 141 in deck clip 133. Using a suitable fastener driving instrument (e.g., a hand-held drill), threaded stem 149 is driven into joist 115 so as to secure deck clip 133 fixedly against top surface 125 of joist 115. As noted briefly above, shelf 145 in deck clip 133 is sized and shaped to receive head 147 of fastener 135 to limit its downward displacement through bore 141.

It should also be noted that, as fastener 135 is driven into joist 115, fastener 135 ultimately causes head 133 to bow slightly (i.e., so as to have a slightly concave appearance). The bowing of head 133 creates a spring-like effect which serves to strengthen the downward retention force of deck boards 113-1 and 113-2 against joist 115, which is highly desirable.

It should be also be noted that deck clip 133 serves to separate deck boards 113-1 and 113-2 a particular spacing S. However, it is to be understood that spacing S between adjacent deck boards 113-1 and 113-2 is not limited to a fixed distance. Rather, spacing S can be adjusted (e.g., within the range of approximately 0.288 inches and 0.625 inches) based on the particular environmental conditions to which deck system 111 will be subjected, which is highly desirable.

The particular design of deck clip 133 provides deck system 111 with a plurality of notable advantages and, as a result, serves the principal novel feature of the present invention. A list of advantages which are realized due to the particular construction of deck clip 133 are enumerated below.

As a first advantage, deck clip 133 is designed so as to be substantially symmetrical about its longitudinal axis 143. As a result of its symmetrical construction, deck clip 133 need not be rotated about its longitudinal axis 143 in order for it to fit in place within grooves 123-1 and 123-2 in deck boards 113-1 and 113-2, respectively. As a consequence, the particular design of deck clip 133 promotes greater ease in use which, in turn, can result in a faster overall installation process, which is highly desirable.

As a second advantage, deck clip 133 is preferably constructed out of plastic. As a result, deck clip 133 is not only durable and light in weight (approximately 0.0029 pounds) but also less susceptible to rusting than conventional metal deck clips, which is highly desirable.

As a third advantage, deck clip 133 and fastener 135 are designed for use between adjacent deck boards 113. As a result, deck clip 133 and fastener 135 are relatively hidden from view, which is highly desirable. This, in turn, provides deck system 111 with a clean, professional look which is aesthetically pleasing.

As a fourth advantage, deck clip 133 and fastener 135 together serve to create a strong and secure bond between the deck boards 113 and joists 115. Specifically, as noted above, with fastener 135 driven into joist 115, deck clip 133 creates a spring-like retention force which serves to strengthen the force of the individual deck boards 113 against the transverse joist 115, which is highly desirable.

As a fifth advantage, deck clip 133 can be used to promote consistent spacing between adjacent deck boards 113 which, in turn, provides deck system 111 with a professional appearance, which is highly desirable.

It should be noted that numerous modifications could be to deck clip 133 without departing from the spirit of the present invention. For example, one or more cut lines could be formed into head 137 of deck clip 133 (i.e., such that head 137 would have a plurality of arcuate sections of a common radius) in order to minimize the amount of material used to form deck clip 133.

The embodiment shown in the present invention is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A deck clip for use in securing at least one deck board to a joist, the deck clip comprising:
(a) a stem, and
(b) an enlarged head formed on the stem, the head and the stem being shaped to define an elongated bore and a longitudinal axis,
(c) wherein the enlarged head is substantially symmetrical about the longitudinal axis.

2. The deck clip as claimed in claim 1 wherein the enlarged head is substantially annular in shape.

3. The deck clip as claimed in claim 2 wherein the stem is substantially cylindrical in shape.

4. The deck clip as claimed in claim 3 wherein the head is formed on the stem in co-axial alignment therewith.

5. The deck clip as claimed in claim 4 wherein the longitudinal axis extends through the center of the elongated bore.

6. The deck clip as claimed in claim 5 wherein said deck clip is a unitary member.

7. The deck clip as claimed in claim 6 wherein said deck clip is constructed out of plastic.

8. The deck clip as claimed in claim 7 wherein said deck clip is constructed out of glass-filled nylon.

9. The deck clip as claimed in claim 5 wherein the enlarged head is shaped to define a shelf immediately surrounding the bore.

10. A deck system comprising:
(a) a joist, the joist comprising a top edge and a bottom edge,
(b) a pair of deck boards disposed transversely across the top edge of the joist, each deck board comprising a top surface, a bottom surface and a pair of side edges, each deck board being shaped to define a slot in at least one of its side edges,
(c) a deck clip shaped to define a longitudinal bore, the deck clip comprising a substantially cylindrical stem and a substantially annular head which are in coaxial alignment with one another, the annular head of the deck clip being sized and shaped to frictionally fit within the slot formed in each of the pair of deck boards, and
(d) a fastener sized and shaped to extend through the longitudinal bore in the deck clip and into the joist.

11. The deck system as claimed in claim 10 wherein the deck clip includes a longitudinal axis.

12. The deck system as claimed in claim 11 wherein the enlarged head of the deck clip is substantially symmetrical about its longitudinal axis.

13. The deck system as claimed in claim 12 wherein the deck clip is a unitary member.

14. The deck system as claimed in claim 13 wherein the deck clip is constructed out of plastic.

15. The deck system as claimed in claim 14 wherein the deck clip is constructed out of glass-filled nylon.

16. The deck system as claimed in claim 12 wherein the deck clip is shaped to define a shelf immediately surrounding the longitudinal bore.

17. The deck system as claimed in claim 16 wherein the fastener includes a head and a stem.

18. The deck system as claimed in claim 17 wherein the fastener is in the form of a screw.

19. The deck system as claimed in claim 17 wherein the head of the screw is sized and shaped to engage the shelf formed in the deck clip.

20. The deck system as claimed in claim 19 wherein each of the pair of deck boards is constructed out of a hardwood, composite or synthetic material.
